(19) United States
(12) Patent Application Publication
(10) Pub. No.: US 2011/0302525 A1
(43) Pub. Date: Dec. 8, 2011

(54) METHOD AND APPARATUS FOR DISPLAYING MESSAGE LIST IN MOBILE TERMINAL

(75) Inventor: Yong Joon JEON, Hwaseong-si (KR)

(73) Assignee: SAMSUNG ELECTRONICS CO. LTD., Suwon-si (KR)

(21) Appl. No.: 13/106,211

(22) Filed: May 12, 2011

(30) Foreign Application Priority Data
Jun. 4, 2010 (KR) 10-2010-0052912

(51) Int. Cl. G06F 3/048

(52) U.S. Cl. 715/786

(57) ABSTRACT

A chat window type message list display method and a mobile terminal employing the method for displaying messages communicated with a messaging counterpart are provided. A message list display method for a mobile terminal according to the present invention includes loading, when a contact item that represents a messaging counterpart is selected, a predefined number of messages communicated most recently with the messaging counterpart among a plurality of messages communicated with the messaging counterpart, arranging the most recently communicated messages in descending order of communicated times in a direction from bottom to top of a screen, displaying a scroll bar region and a scroll bar situated at bottom end of the scroll bar region, and shrinking, while the rest of the plurality of the messages communicated with the messaging counterpart are loaded, the scroll bar downward in length according to a number of the messages loaded.

### PRIORITY

This application claims the benefit under 35 U.S.C. §119(a) of a Korean patent application filed on Jun. 4, 2010 in the Korean Intellectual Property Office and assigned Serial No. 10-2010-0052912, the entire disclosure of which is hereby incorporated by reference.

### BACKGROUND OF THE INVENTION

1. Field of the Invention

The present invention relates to a mobile terminal. More particularly, the present invention relates to a chat window type message list display method and apparatus of a mobile terminal for displaying messages communicated with a messaging counterpart.

2. Description of the Related Art

With the widespread use of mobile telephony, a mobile terminal has become one of the necessities of modern life. Furthermore, the mobile terminal has evolved into a mobile multimedia communication terminal supporting various supplementary services including a data transmission service as well as a conventional voice call service.

More particularly, the use of a Short Messaging Service (SMS) and a Multimedia Messaging Service (MMS) has been increasing. A user of the mobile terminal can transmit and receive the SMS/MMS messages and check the received messages, in the message inbox of the mobile terminal, and the sent message, in the message outbox of the mobile terminal.

Recently, there is a trend to show a list of messages communicated with a specific person in the form of a chat window. The chat window type message display is likely to be adopted universally for mobile communication devices. Therefore, research is ongoing to develop user interfaces for a chat window type message list that is capable of improving user convenience.

### SUMMARY OF THE INVENTION

An aspect of the present invention is to address at least the above-mentioned problems and/or disadvantages and to provide at least the advantages described below. Accordingly, an aspect of the present invention is to provide a method and apparatus for displaying a message list in the form of a chat window user interface that is capable of improving user convenience.

In accordance with an aspect of the present invention, a message list display method for a mobile terminal is provided. The method includes loading, when a contact item that represents a messaging counterpart is selected, a predefined number of messages communicated most recently with the messaging counterpart among a plurality of messages communicated with the messaging counterpart, arranging the most recently communicated messages in descending order of communicated times in a direction from bottom to top of a screen, displaying a scroll bar region and a scroll bar situated at bottom end of the scroll bar region, and shrinking, while the rest of the plurality of the messages communicated with the messaging counterpart are loaded, the scroll bar downward in length according to a number of the messages loaded.

In accordance with another aspect of the present invention, a method for displaying a message list of a mobile terminal is provided. The method includes loading, when a contact item that represents a messaging counterpart is selected, a predefined number of messages communicated most recently with the messaging counterpart among a plurality of messages communicated with the messaging counterpart, configuring a virtual window in which the most recently communicated messages are ordered by communicated time in a direction from top to bottom, forming a scroll bar region along a side of the virtual window and a scroll bar situated at bottom end of the scroll bar region, inverting the virtual window upside down, the inverted virtual window having the loaded messages ordered by communicated time in a direction from the bottom to the top and the scroll bar region in which the scroll bar is situated at the top end, shrinking, while the rest of the plurality of the messages communicated with the messaging counterpart are loaded, the scroll bar upward in length according to a number of the messages loaded, and re-inverting the virtual window upside down to shrink the scroll bar downward.

In accordance with another aspect of the present invention, a mobile terminal is provided. The mobile terminal includes an input unit for selecting a contact item, a storage unit for storing a plurality of messages communicated with a messaging counterpart represented by the contact item, a control unit for loading, when the contact item is selected, a predefined number of messages communicated most recently with the messaging counterpart among the plurality of the messages communicated with the messaging counterpart, for arranging the most recently communicated messages in descending order of communicated times in a direction from bottom to top of a screen, for displaying a scroll bar region and a scroll bar situated at bottom end of the scroll bar region, and for shrinking, while the rest of the plurality of the messages communicated with the messaging counterpart are loaded, the scroll bar downward in length according to a number of the messages loaded, and a display unit for displaying the loaded messages ordered by communicated time in a direction from bottom to top of a screen along with the scroll bar along a side of the screen.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating a configuration of a mobile terminal according to an exemplary embodiment of the present invention;

FIG. 2 is a flowchart illustrating a message list display method of a mobile terminal according to an exemplary embodiment of the present invention;

FIG. 3 is a flowchart illustrating a message list display method of a mobile terminal according to another exemplary embodiment of the present invention;

FIG. 4 is a diagram illustrating a series of screens corresponding to steps for presenting a message list in a message list display method according to an exemplary embodiment of the present invention; and

FIGS. 5A and 5B are diagrams illustrating a series of screens corresponding to steps for presenting a message list in a message list display method according to another exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, description of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the following description, a mobile terminal 100 can be any of a Code Division Multiple Access (CDMA) terminal, a Wideband CDMA (WCDMA) terminal, a Global System For Mobile communication (GSM) terminal, an International Mobile Telecommunication 2000 (IMT-2000) terminal, a Universal Mobile Telecommunication Service (UMTS) terminal, a Personal Digital Assistant (PDA), a Smartphone, etc.

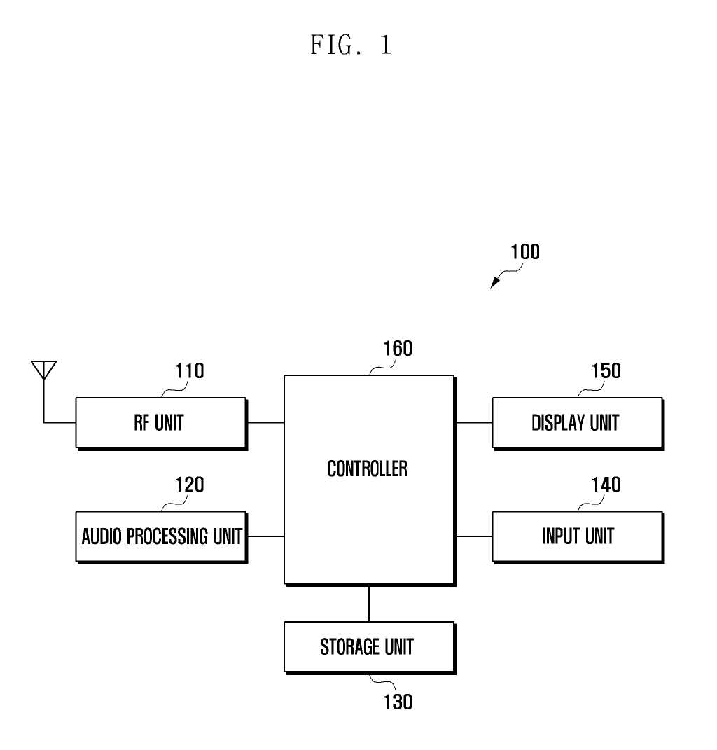

FIG. 1 is a block diagram illustrating a configuration of a mobile terminal according to an exemplary embodiment of the present invention. Referring to FIG. 1, the mobile terminal 100 includes a Radio Frequency (RF) unit 110, an audio processing unit 120, a storage unit 130, an input unit 140, a display unit 150, and a control unit 160.

The RF unit 110 is responsible for transmitting/receiving radio signals carrying data. The RF unit 110 can include an RF transmitter for up-converting and amplifying the transmit signal and an RF receiver for low noise amplifying and down-converting the receive signal. The RF unit 110 delivers the data received over the radio channel to the control unit 160 and transmits the data output by the control unit 160 through the radio channel. More particularly in an exemplary embodiment of the present invention, the RF unit 110 transmits the radio signals carrying Short Messaging Service (SMS) and Multimedia Messaging Service (MMS) messages destined to another mobile terminal (i.e., a messaging counterpart).

The audio processing unit 120 can include a codec pack containing a data codec for processing packet data and an audio codec for processing an audio signal including voice. The audio processing unit 120 converts a digital audio signal into an analog audio signal by means of the audio codec to output the analog audio signal through the speaker (SPK) in the form of an audio sound wave and converts an analog audio signal input through the microphone (MIC) into a digital audio signal by means of the audio codec.

The storage unit 130 stores programs and data used for operating the mobile terminal and can be divided into a program region and a data region. The program region stores an Operating System (OS) for booting the mobile terminal 100, application programs used for playing multimedia contents, and other programs used for supporting supplementary functions such as a camera function, a sound playback function, and still and motion picture playback functions. The data region stores the data generated as a result of the operation of the mobile terminal 100 such as still and motion pictures, a phonebook, and audio files. In an exemplary embodiment of the present invention, the program region of the storage unit 130 stores the application programs for transmitting/receiving and managing the SMS and MMS messages. The data region of the storage unit 130 stores the messages communicated with other mobile terminals (i.e., a messaging counterparts). In an exemplary embodiment of the present invention, the storage unit 130 stores the messages along with the transmitted/received time information and contact information. Here, the contact information refers to the contact information of the counterpart of the message communication.

The input unit 140 detects a key entry and sends the key signal corresponding to the key entry to the control unit 160. The input unit 140 can be implemented with one of a 3×4 keypad and a QWERTY keypad composed of alphanumeric and navigation keys and a touch panel. The input unit 140 also can include at least one of a button key, a jog key, and a wheel key. The input unit 140 generates a key signal for executing an application (for a call function, a music playback function, a video playback function, an image display function, a camera function, a Digital Multimedia Broadcasting (DMB) playback function, etc.) and sends the key signal to the control unit 160. More particularly, in an exemplary embodiment of the present invention, the input unit 140 generates and sends a message list function execution signal and a contact selection signal to the control unit 160.

The display unit 150 can be implemented with one of a Liquid Crystal Display (LCD), an Organic Light Emitting Diodes (OLED), and an Active Matrix OLED (AMOLED) for displaying the menus, input data, function setting information, and other information in the form of a visual image. The display unit 150 is responsible for displaying a booting screen, a standby mode screen, a menu screen, a call progressing screen, and other application execution screens. More particularly, in an exemplary embodiment of the present invention, the display unit 150 displays a message list screen presenting a message list composed of message items and a scroll bar for navigating the message items.

The control unit 160 controls the operations of internal function blocks of the mobile terminal 100. According to an exemplary embodiment of the present invention, the control unit 160 monitors to detect a message list selection signal input by means of the input unit 140. If the message list selection signal input is detected, the control unit 160 controls such that the contact list is displayed on the display unit 150.

The control unit 160 detects the selection of a contact item according to the signal input through the input unit 140 and loads, from the storage unit 130, a predefined number of the most recent messages among all messages communicated with the messaging counterpart represented by the contact item in descending order of time.

The control unit 160 controls such that the messages loaded from the storage unit 130 are presented in the form of a list in which the message items are ordered in descending order from the top to the bottom. The control unit 160 controls such that a scroll bar display region is provided at a side of the message list screen along with a scroll bar having a length corresponding to the number of loaded messages, wherein the scroll bar maintains contact with the bottom side of the screen. The control unit 160 controls such that the messages communicated with the messaging counterpart are listed from the top to the bottom in descending order. The control unit 160 controls such that the scroll bar decreases in length while maintaining its contact with the bottom end of the scroll bar region as the number of loaded messages increases.

According to an exemplary embodiment of the present invention, the control unit 160 monitors to detect a command input by means of the input unit 140 so as to display, when a message list display command is detected, the contact list on the screen of the display unit 150 and, when a contact selection command is detected, a predefined number of recent messages among all the messages communicated with the messaging counterpart represented by the selected contact. The messages loaded from the storage unit 130 are listed in descending order of communicated time within a virtual window having a scroll bar display region with a scroll bar of which one end is in contact with the top end of the scroll bar display region. The control unit 160 controls to invert the virtual window upside down such that the messages are listed in ascending order of communicated time and the scroll bar is in contact with the bottom end of the scroll bar region. The control unit 160 controls such that the rest of the messages loaded from the storage unit 130 are listed in descending order of the communicated time from the bottom to the top of the virtual window. The control unit 160 also controls such that the scroll bar decreases in length while maintaining in contact with the top end of the scroll bar region as the number of messages increases. The control unit 160 controls to invert the virtual window upside down such that the scroll bar decreases in length while maintaining in contact with the bottom end of the scroll bar region.

Taking the above-described internal configuration of the mobile terminal into consideration, a description is made of the message list display method of the mobile terminal hereinafter.

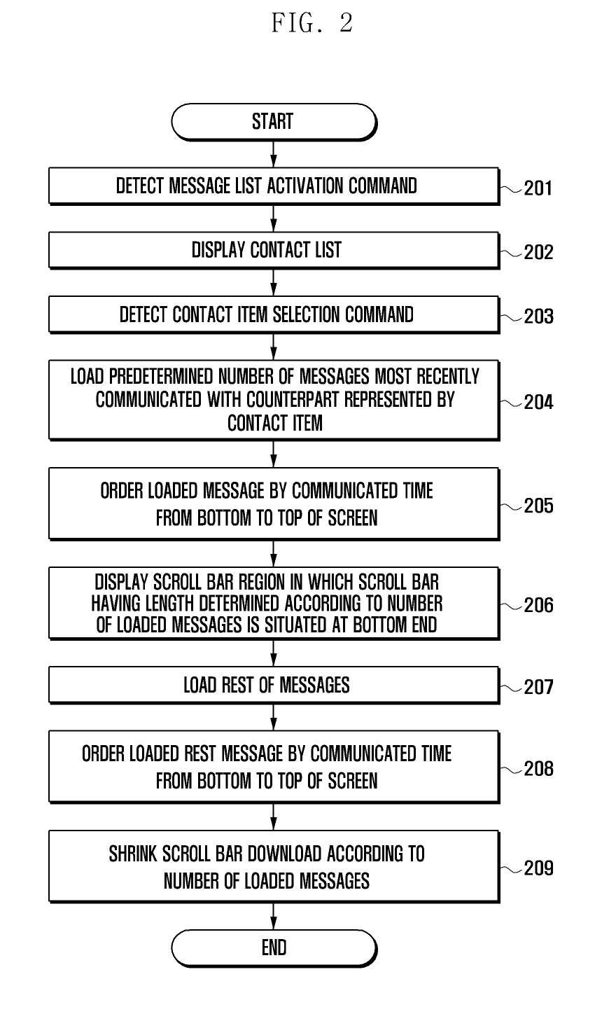

FIG. 2 is a flowchart illustrating a message list display method of a mobile terminal according to an exemplary embodiment of the present invention.

Referring to FIG. 2, the control unit 160 detects a message list activation command input by means of the input unit 140 in step 201. The user can perform an input action to a key of the key input unit 140 for activating a message list such that the input unit 140 transports a corresponding key signal to the control unit 160. The control unit 160 can recognize the key signal sent by the input unit 140 as the message list activation command.

If the message list activation command is received, the control unit 160 controls such that a contact list is displayed on the screen of the display unit 150 in step 202. The contact list is composed of a plurality of contact items representing the individual messaging counterparts with which the user can communicate a message.

The control unit 160 monitors to detect a user input and, if an input action is performed to one of the contact items in the contact list by means of the input unit 140, recognizes the signal sent by the input unit 140 as a contact item selection command in step 203. The user can select a contact item from the contact list by performing a selection action to the contact item.

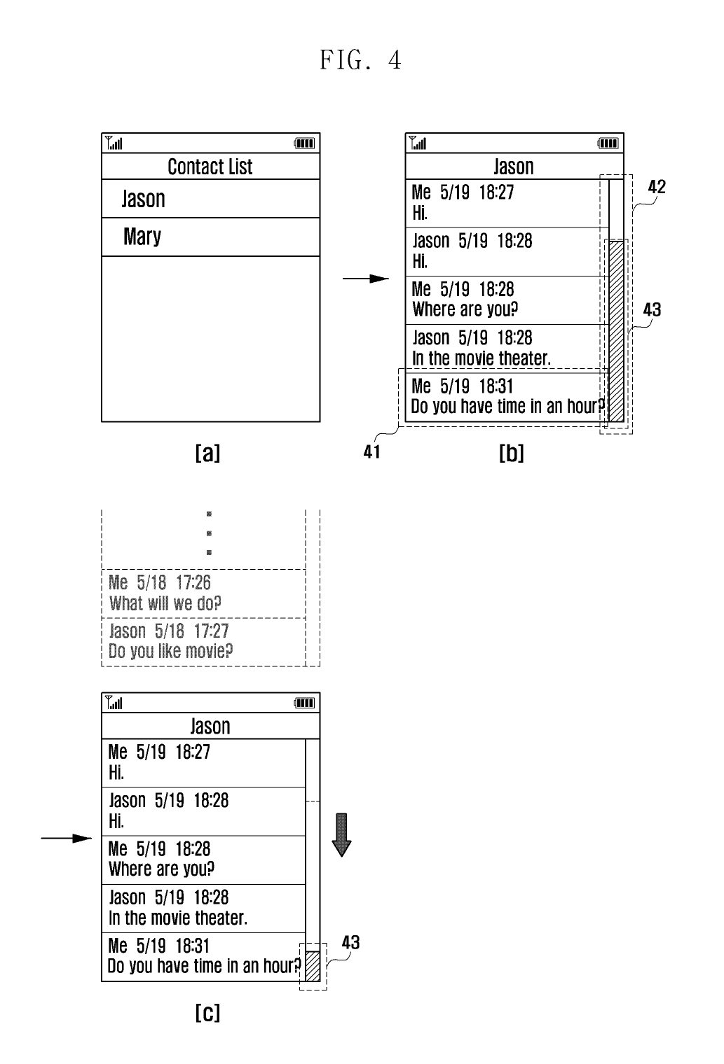

FIG. 4 is a diagram illustrating a series of screens corresponding to steps for presentation of a message list in a message list display method according to an exemplary embodiment of the present invention.

Referring to FIG. 4, part [a] shows a contact list screen that is displayed when the message list activation command is detected. In part [a] of FIG. 4, the contact list screen presents a contact list including two contact items labeled ‘Jason’ and ‘Mary.’ In this exemplary case, the user selects the contact item labeled ‘Jason’ by means of the input unit 140.

Returning to FIG. 2, if the user input for selecting one of the contact items is detected, the control unit 160 loads, from the storage unit 130, a predefined number of the most recently communicated messages among all the messages communicated with the messaging counterpart represented by the selected contact item in step 204. For example, when the predefined number of messages is five, the control unit 160 loads the five most recently communicated messages exchanged with the messaging counterpart represented by the selected contact item from the storage unit 130.

Next, the control unit 160 arranges the loaded messages in descending order of time from the bottom to the top of the message list in step 205. For example, when the first to fifth most recently communicated messages are loaded from the storage unit 130, the control unit 160 controls such that the first most recently communicated message is placed at the bottom of the list and the fifth most recently communicated message is placed at the top of the list.

The control unit 160 controls such that a scroll bar having a length corresponding to the number of loaded messages is presented in a scroll bar region in step 206. According to an exemplary embodiment of the present invention, the control unit 160 designates a part of the screen as the scroll bar region of which a bottom end is a reference point of the scroll bar. Accordingly, the scroll bar is positioned in the scroll bar region such that one end of the scroll bar is in contact with the bottom end of the scroll bar region.

Referring again to FIG. 4, part [b] shows a message list screen that is displayed when the contact item labeled ‘Jason’ is selected from the contact list screen as shown in part [a] of FIG. 4. In part [b] of FIG. 4, the message list screen presents a message list including five message items, i.e., the first most recently communicated message (Me, 5/19, 18:31, Do you have time in an hour?) 41 to fifth most recently communicated message (Me, 5/19, 18:27, Hi.) that are ordered from the bottom to the top in descending order of communicated times. The message list screen also has the scroll bar region 42 in which the scroll bar 43 is positioned such that one end the scroll bar 43 is in contact with the bottom end of the scroll bar region 42. The scroll bar 43 is determined such that its length corresponds to the number of message items (five in this example).

Returning to FIG. 2, the control unit 160 loads the rest of the messages communicated with the messaging counterpart represented by the contact item from the storage unit 130 in step 207. For example, when the total number of messages communicated with the counterpart represented by the selected contact item is one hundred and the five most recently communicated messages are loaded at step 204, the control unit 160 loads the remaining ninety five messages at step 207.

After loading the rest of the messages, the control unit 160 arranges the message items in descending order from the bottom to the top in the list in step 208. At step 208, the remaining messages are arranged in descending order from the bottom to the top. For example, when ninety five remaining messages are loaded among a total of one hundred messages, the sixth most recently communicated message is placed above the fifth most recently communicated message and, in the same manner, the seventh most recently communicated message is placed above the sixth most recently communicated message in the message list.

Next, the control unit 160 adjusts the length of the scroll bar so as to be shortened inversely proportional to the number of the loaded messages in step 209. At this time, the scroll bar maintains its contact with the bottom end of the scroll bar region while shortening in length.

Referring again to FIG. 4, part [c] shows the message list screen that is displayed when all the remaining messages are loaded. As shown in part [c] of FIG. 4, the scroll bar 43 is shorter in length as compared to part [b] of FIG. 4. The scroll bar is shortened while one end thereof maintains in contact with the bottom of the scroll bar region 42.

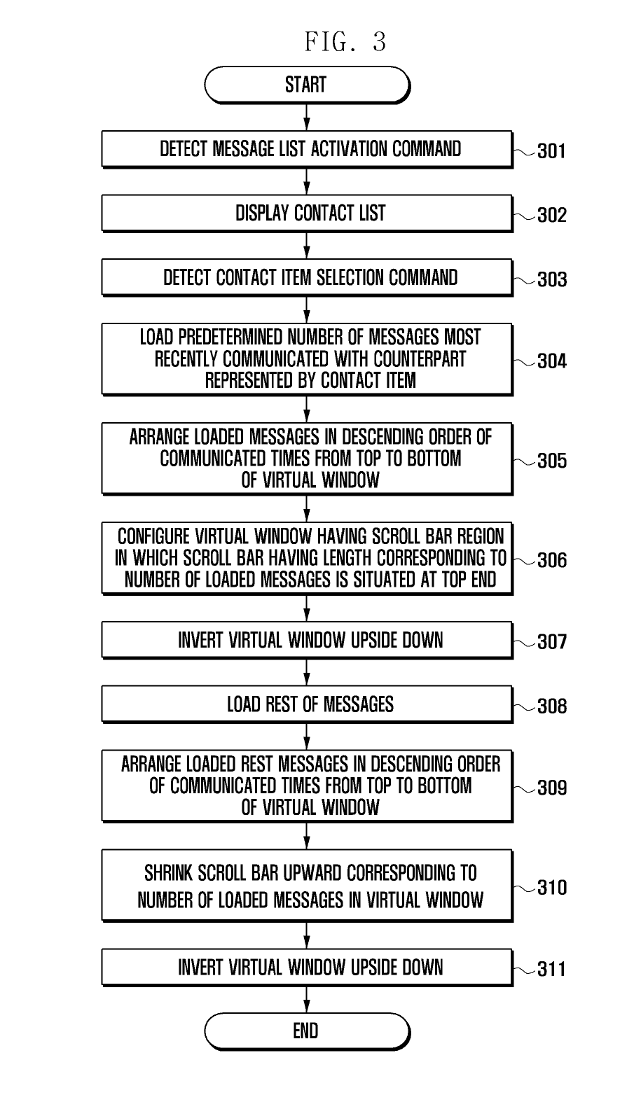

FIG. 3 is a flowchart illustrating a message list display method of a mobile terminal according to another exemplary embodiment of the present invention. In this exemplary embodiment, a message list is configured in a virtual window and then the virtual window is presented as inverted upside down.

Referring to FIG. 3, steps 301 to 304 are identical with steps 201 to 204 of FIG. 2. Accordingly, the descriptions of steps 301 to 304 of FIG. 3 are also identical to the descriptions of steps 201 to 204 of FIG. 2, and thus their descriptions are omitted for conciseness in explanation. The control unit 160 controls such that the contact list is displayed in response to the message list activation command input by means of the input unit 140 and the message list is displayed in response to the contact item selection command.

Next, the control unit 160 controls such that the loaded messages are arranged in descending order of communicated times from the bottom to the top of the list in step 305. To perform step 305, the control unit 160 creates a virtual window. The virtual window is a logical window presented in the screen of the display unit 150. The virtual window is used for configuring a physical window on the screen of the display unit 150 and has a reference point of a scroll bar positioned at the top end of the scroll bar region. After creating the virtual window, the control unit 160 controls such that the messages are arranged in descending order of the communicated times from the top to the bottom of the virtual window.

The control unit 160 configures the virtual window such that the scroll bar has a length corresponding to the number of the loaded messages and the scroll bar has one end in contact with the top end of the scroll bar region in step 306. According to an exemplary embodiment of the present invention, the control unit 160 designates a region along a side of the virtual window as the scroll bar region and configures the top end of the scroll bar region as the reference point of the scroll bar such that the scroll bar is positioned within the scroll bar region and one end of the scroll bar is in contact with the top end inside wall of the scroll bar region.

The control unit 160 controls such that the virtual window is inverted upside down in step 307. In more detail, the control unit 160 arranges the messages in descending order of the communicated times from the bottom to the top and the scroll bar within the scroll bar region such that one end of the scroll bar is in contact with the bottom end inside wall of the scroll bar region.

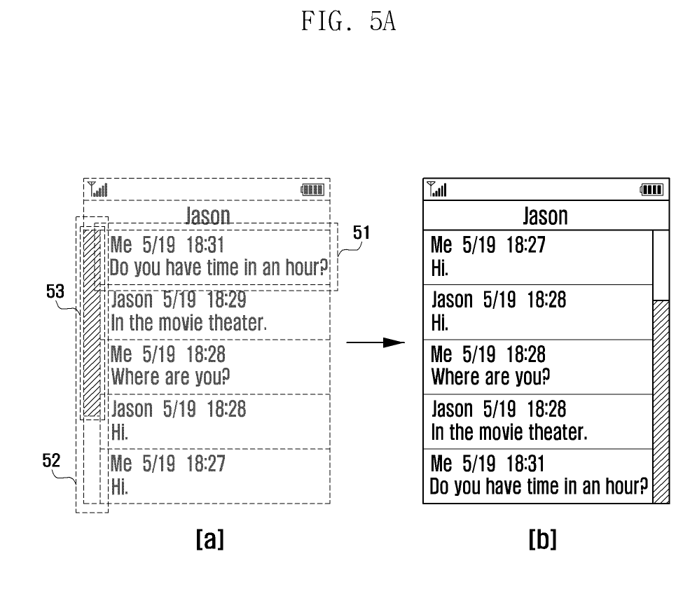

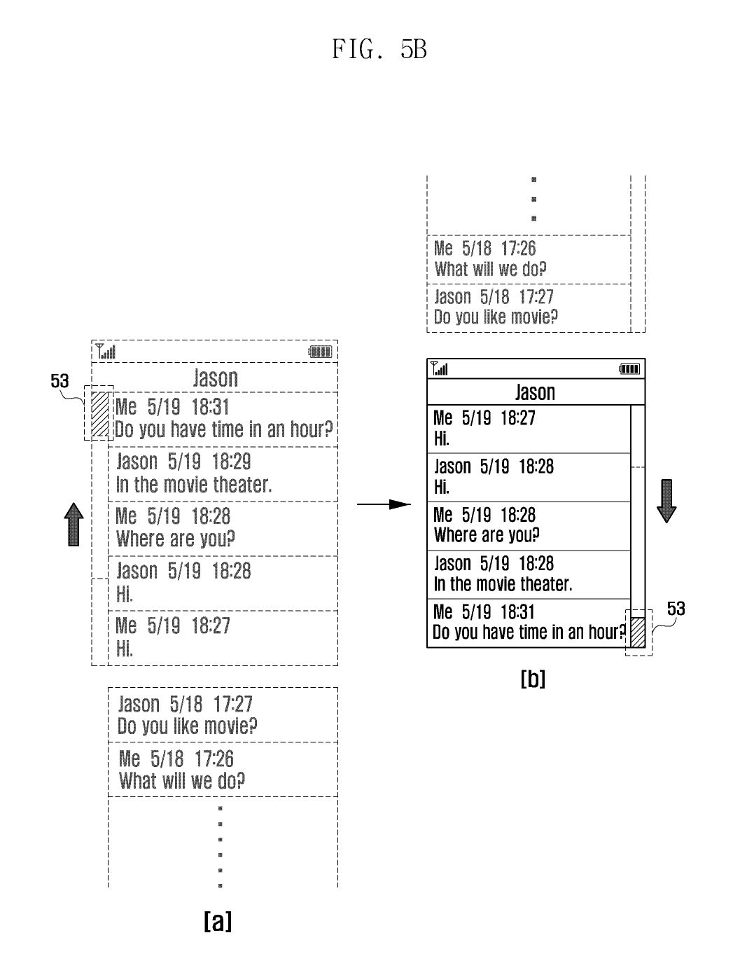

FIGS. 5A and 5B are diagrams illustrating a series of screens corresponding to steps for presentation of a message list in a message list display method according to another exemplary embodiment of the present invention.

Referring to FIG. 5A, part [a] shows a message list presented in the form of a virtual window. As shown in part [a] of FIG. 5a, the message list includes five message items. In the message list, the five message items, i.e. from the first most recently communicated message (Me, 5/19, 18:31, Do you have time in an hour?) 51 to the fifth most recently communicated message (Me, 5/19, 18:27, Hi.) are ordered from the top to the bottom of the list. The message list is provided with the scroll bar region 52 in which the scroll bar 53 is positioned such that one end of the scroll bar 53 is in contact with the top end inside wall of the scroll bar region.

Part [b] of FIG. 5A shows the message list presented after the message items are arranged in order. As compared to the message list in part [a] of FIG. 5a, the message items are arranged in an opposite order in the message list of part [b] of FIG. 5A. Also, the scroll bar region is inverted such that the scroll bar 53 contacts the bottom end inside wall of the scroll bar region.

Returning to FIG. 3, after inverting the virtual window, the control unit 160 loads the rest of the messages communicated with the messaging counterpart represented by the selected contact item in step 308. For example, when five most recently communicated messages are loaded at step 304 among total of one hundred messages communicated with the messaging counterpart, the control unit 160 loads the remaining ninety five messages at step 308.

Next, the control unit 160 arranges the loaded remaining messages in descending order of communicated times from the top to the bottom in step 309. At step 309, the loaded remaining messages are arranged in descending order from the top to the bottom of the list. For example, when the ninety five rest messages are loaded, the sixth most recently communicated message is arranged above the fifth most recently communicated message, the seventh most recently communicated message above the sixth most recently communicated, and so on.

In step 310, the control unit 160 controls such that the scroll bar shrinks upward according to the increase in the number of loaded message items within the virtual window. That is, the scroll bar is shortened in the scroll bar region while maintaining in contact with the top end inside wall of the scroll bar display region.

Referring to FIG. 5B, part [a] shows the message list modified as the remaining messages are loaded. In part [a] of FIG. 5B, the remaining messages are added to the message list in as a series of message items. As compared to the message list of part [a] of FIG. 5A, the scroll bar is shortened in the message list of part [a] of FIG. 5B. The scroll bar 53 shrinks upward while remaining in contact with the top end inside wall of the scroll bar region 52.

Next, the control unit 160 controls such that the virtual window is inverted upside down in step 311. In more detail, the control unit 150 controls such that the scroll bar shrinks downward according to the increase in the number of loaded message items. At this time, the scroll bar is shortened in length while maintaining its contact with the bottom end inside wall of the scroll bar region. The continuously loaded remaining messages are arranged in descending order from the bottom to the top of the list.

Part [b] of FIG. 5B shows the message list modified as the remaining messages are loaded. In part [b] of FIG. 5B, the remaining messages are added to the message list in a direction from the bottom to the top. As compared to part [b] of FIG. 5A, the scroll bar 53 is shortened in part [b] of FIG. 5B. The scroll bar 53 shrinks downward while maintaining its contact with the bottom end inside wall of the scroll bar region 52.

With the message list display method according to an exemplary embodiment of the present invention, the user can check the recently communicated messages quickly. In the conventional method, when the user selects a contact item, the terminal loads all the messages communicated with the messaging counterpart represented by the selected contact item, builds a list of the message items representing the individual messages, and places the focus on the message item at the bottom of the list. In this case, loading all the communicated messages and building the message list with all the loaded messages are time-consuming processes that result in the user having to wait a relatively long time to check the recently communicated messages. Unlike this conventional message list display method, the message list display method according to an exemplary embodiment of the present invention builds a message list with a predefined number of the most recently communicated messages first and displays the message list such that the user can check the recently communicated messages while the rest of the messages are added to the message list in a background process.

The message list display method according to an exemplary embodiment of the present invention allows the user to check the recently communicated messages without shaking of the screen. In the conventional method using the top-down scrolling mechanism in which the most recently communicated message is positioned at the top of the list, it is intended that the focus be on the top of the list and thus the scroll bar is located at the bottom within the scroll bar region. Since the scroll bar is intended to be placed at the bottom end in such top-down mechanism where the reference point of the scroll bar is placed at the top end of the scroll bar region, the scroll bar moves continuously in the middle of the message loading process. The movement of the scroll bar cause shaking of the message list screen, resulting in inconvenience to a user. In the message list display method using the down-top mechanism according to an exemplary embodiment of the present invention, unlike this conventional method, since the scroll bar has its reference point at the bottom of the screen and is intended to be located at the bottom of the screen, it is possible to avoid shaking of the message list screen.

As described above, the message list display method for a mobile terminal according to exemplary embodiments of the present invention are capable of displaying the recently communicated messages quickly in the chatting window type message list. Also, the message list display method for a mobile terminal according to exemplary embodiments of the present invention places the reference point of the scroll bar at the bottom of the scroll bar region, thereby avoiding the occurrence of a screen shaking effect when the loaded messages are placed on the top of the list.

While the invention has been shown and described with reference to certain exemplary embodiments thereof, it will be understood by those skilled in the art that various changes in form and details may be made therein without departing from the spirit and scope of the invention as defined in the appended claims and their equivalents.

What is claimed is:

1. A message list display method for a mobile terminal, the method comprising:
loading, when a contact item that represents a messaging counterpart is selected, a predefined number of messages communicated most recently with the messaging counterpart among a plurality of messages communicated with the messaging counterpart;
arranging the most recently communicated messages in descending order of communicated times in a direction from bottom to top of a screen;
displaying a scroll bar region and a scroll bar situated at bottom end of the scroll bar region; and
shrinking, while the rest of the plurality of the messages communicated with the messaging counterpart are loaded, the scroll bar downward in length according to a number of the messages loaded.

2. The method of claim 1, wherein the shrinking comprises maintaining the position of the scroll bar at the bottom of the scroll bar region.

3. The method of claim 1, further comprising configuring, before displaying the scroll bar region, a reference point of the scroll bar at the bottom of the scroll bar region.

4. The method of claim 1, wherein the shrinking comprises arranging the rest of the plurality of the messages communicated with the messaging counterpart in descending order of communicated times in a direction from the bottom to the top.

5. The method of claim 1, wherein the plurality of the messages communicated with the messaging counterpart comprises at least one of Short Messaging Service (SMS) messages and Multimedia Messaging Service (MMS) messages.

6. A method for displaying a message list of a mobile terminal, method comprising:
loading, when a contact item that represents a messaging counterpart is selected, a predefined number of messages communicated most recently with the messaging counterpart among a plurality of messages communicated with the messaging counterpart;
configuring a virtual window in which the most recently communicated messages are ordered by communicated time in a direction from top to bottom;
forming a scroll bar region along a side of the virtual window and a scroll bar situated at bottom end of the scroll bar region;
inverting the virtual window upside down, the inverted virtual window having the loaded messages ordered by communicated time in a direction from the bottom to the top and the scroll bar region in which the scroll bar is situated at the top end;
shrinking, while the rest of the plurality of the messages communicated with the messaging counterpart are loaded, the scroll bar upward in length according to a number of the messages loaded; and
re-inverting the virtual window upside down to shrink the scroll bar downward.

7. The method of claim 6, wherein the shrinking comprises shortening the scroll bar upward while maintaining contact with the top end of the scroll bar region.

8. The method of claim 6, further comprising configuring, before forming the scroll bar region, a reference point of the scroll bar at the top of the scroll bar region.

9. The method of claim 8, further comprising re-configuring, after forming the scroll bar region, the reference point of the scroll bar at the bottom of the scroll bar region.

10. The method of claim 6, wherein the shrinking comprises arranging the loaded rest of the plurality of the messages communicated with the messaging counterpart in descending order of communicated time in a direction from top to bottom.

11. The method of claim 6, wherein the plurality of the messages communicated with the messaging counterpart comprises at least one of Short Messaging Service (SMS) messages and Multimedia Messaging Service (MMS) messages.

12. A mobile terminal comprising:
an input unit for selecting a contact item;
a storage unit for storing a plurality of messages communicated with a messaging counterpart represented by the contact item;
a control unit for loading, when the contact item is selected, a predefined number of messages communicated most recently with the messaging counterpart among the plurality of the messages communicated with the messaging counterpart, for arranging the most recently communicated messages in descending order of communicated times in a direction from bottom to top of a screen, for displaying a scroll bar region and a scroll bar situated at bottom end of the scroll bar region, and for shrinking, while the rest of the plurality of the messages communicated with the messaging counterpart are loaded, the scroll bar downward in length according to a number of the messages loaded; and
a display unit for displaying the loaded messages ordered by communicated time in a direction from bottom to top of a screen along with the scroll bar along a side of the screen.

13. The mobile terminal of claim 12, wherein the control unit configures, before displaying the scroll bar region, a reference point of the scroll bar at the bottom of the scroll bar region.

14. The mobile terminal of claim 12, wherein the control unit arranges the rest of the plurality of the messages communicated with the messaging counterpart in descending order of communicated times in a direction from the bottom to the top.

15. The mobile terminal of claim 12, wherein the control unit loads, when the contact item that represents the messaging counterpart is selected, the predefined number of messages communicated most recently with the messaging counterpart among the plurality of the messages communicated with the messaging counterpart, configures a virtual window in which the most recently communicated messages are ordered by communicated time in a direction from top to bottom, forms the scroll bar region along a side of the virtual window and the scroll bar situated at bottom end of the scroll bar region, and inverts the virtual window upside down, the inverted virtual window having the loaded messages ordered by communicated time in a direction from the bottom to the top and the scroll bar region in which the scroll bar is situated at the top end; and
the display unit displays a window formed by inverting the virtual window upside down in which the loaded messages are ordered by communicated time in the direction from the bottom to the top, the scroll bar is situated at the bottom of the scroll bar region, and the scroll bar shrinks, while the rest of the plurality of messages communicated with the messaging counterpart are loaded, downward in length according to a number of the messages loaded.

16. The mobile terminal of claim 15, wherein the control unit configures a reference point of the scroll bar at the top of the scroll bar region in the virtual window and at the bottom of the scroll bar region in a window presented on the display unit.

17. The mobile terminal of claim 12, wherein the plurality of the messages communicated with the messaging counterpart comprises at least one of Short Messaging Service (SMS) messages and Multimedia Messaging Service (MMS) messages.
